(19) United States
(12) Patent Application Publication
(10) Pub. No.: US 2014/0334284 A1
(43) Pub. Date: Nov. 13, 2014

(54) TRANSMITTER AND RECEIVER FOR WIRELESS COMMUNICATION USING REVOLUTION DIVISION MULTIPLEXING, AND SIGNAL TRANSMISSION AND RECEPTION METHOD THEREOF

(71) Applicant: Electronics And Telecommunications Research Institute, Daejeon (KR)

(72) Inventors: Woo Jin BYUN, Daejeon (KR); Yong Heui CHO, Daejeon (KR); Kwang Seon KIM, Daejeon (KR); Min soo KANG, Daejeon (KR); Bong-Su KIM, Daejeon (KR)

(73) Assignee: Electronics And Telecommunications Research Institute, Daejeon (KR)

(21) Appl. No.: 13/964,253

(22) Filed: Aug. 12, 2013

(30) Foreign Application Priority Data
May 7, 2013 (KR) 10-2013-0051271

(51) Int. Cl. H04J 11/00

(52) U.S. Cl. CPC H04J 11/00
USPC 370/208; 370/328

(57) ABSTRACT

A signal transmission and reception method includes generating a plurality of electromagnetic wave mode functions having orthogonality in a spatial domain using a plurality of input signals, synthesizing and wirelessly transmitting the generated electromagnetic wave mode functions, receiving a revolution division multiplexing electromagnetic wave having characteristics of phase rotation in directions of an azimuth angle and an elevation angle, and discriminating the electromagnetic wave mode functions through an orthogonal operation, and restoring an output signal through correction of the discriminated electromagnetic wave mode functions.

### RELATED APPLICATIONS(S)

This application claims the benefit of Korean Patent Application No. 10-2013-0051271, filed on May 7, 2013, which is hereby incorporated by references as if fully set forth herein.

### FIELD OF THE INVENTION

The present invention relates to a wireless communication multiplexing technique, and more particularly to a transmitter and a receiver for wireless communication using revolution division multiplexing and a signal transmission and reception method thereof, which are suitable to modulate a phase of an electromagnetic wave with an azimuth angle and an elevation angle, which are two-dimensional (2D) rotation angles, so that multiplexing is possible with respect to the same frequency and the same polarized wave in a ultra high frequency (UHF) band.

### BACKGROUND OF THE INVENTION

As is well known, as various wireless communication applications are produced, most of the UHF band has been allocated to services and used. Particularly, in consideration of the system size of wireless/mobile communication and propagation distance characteristics, the UHF band may be the most efficient frequency band for wireless/mobile communication.

Under the present situation, in consideration of the explosive growth of the wireless/mobile communication to be generated in the near future, a new multiplexing technology that enables efficient use of the frequencies is necessarily required. That is, the advent (rise) of a new multiplexing technology, which can discriminate between signals even using the same frequency and the same polarized wave, may be essential.

### SUMMARY OF THE INVENTION

The present invention proposes a technique for phase modulation of an azimuth angle and an elevation angle in the order of numbers of mode functions so as to discriminate the same frequency and the same polarized wave on the basis of completeness and orthogonality of the mode functions that are used in the electromagnetic wave theory. Since the phase modulation of the azimuth angle and the elevation angle is shaped as if the waves are rotated, it is hereinafter defined as revolution division multiplexing.

According to the present invention, since the multiplexing can be realized through effective discrimination of signals while using the same frequency and the same polarized wave in the UHF band into which application services of wireless/mobile communication have actively been introduced, the use efficiency of the frequencies can be maximized.

In accordance with an aspect of the exemplary embodiment of the present invention, there is provided a transmitter for wireless communication using revolution division multiplexing, which includes a mode generation unit, which generates a plurality of electromagnetic wave mode functions having orthogonality in a spatial domain using a plurality of input signals, and an electromagnetic wave synthesis and transmission unit, which synthesizes and wirelessly transmits the generated electromagnetic wave mode functions through a transmission antenna.

In the exemplary embodiment, the mode generation unit may generate the plurality of electromagnetic wave mode functions through adjustment of a surface structure of the transmission antenna.

In the exemplary embodiment, the mode generation unit may generate the plurality of electromagnetic wave mode functions through adjustment of amplitude and phase characteristics of elements of the transmission antenna.

In the exemplary embodiment, the elements of the transmission antenna correspond to a current density of an array antenna.

In the exemplary embodiment, the electromagnetic wave synthesis and transmission unit may radiate the plurality of electromagnetic wave mode functions into space as rotating phases in directions of an azimuth angle and an elevation angle in the form of an electromagnetic wave.

In accordance with another aspect of the exemplary embodiment of the present invention, there is provided a receiver for wireless communication using revolution division multiplexing, which includes an orthogonal operation unit discriminating electromagnetic wave mode functions through an orthogonal operation of a revolution division multiplexing electromagnetic wave having characteristics of phase rotation in directions of an azimuth angle and an elevation angle that is received through a reception antenna, and a mode correction unit restoring an output signal through correction of the discriminated electromagnetic wave mode functions.

In the exemplary embodiment, the output signal may be restored through the following equation:

J=G⁻¹A′=G⁻¹OE

where, J denotes output signals to be restored, G⁻¹ denotes a configuration of the mode correction unit as an inverse matrix of a mode generation unit on a transmitter side, A′ denotes a matrix composed of mode function coefficients Aₙₘ,Bₙₘ generated in the receiver, E denotes an electric field matrix measured in the receiver, and O denotes a matrix of the orthogonal operation unit that discriminates the mixed mode functions.

In accordance with further another aspect of the exemplary embodiment of the present invention, there is provided a signal transmission and reception method for wireless communication using revolution division multiplexing, which includes generating a plurality of electromagnetic wave mode functions having orthogonality in a spatial domain using a plurality of input signals, synthesizing and wirelessly transmitting the generated electromagnetic wave mode functions, receiving a revolution division multiplexing electromagnetic wave having characteristics of phase rotation in directions of an azimuth angle and an elevation angle, and discriminating the electromagnetic wave mode functions through an orthogonal operation, and restoring an output signal through correction of the discriminated electromagnetic wave mode functions.

### BRIEF DESCRIPTION OF THE DRAWINGS

The objects and qualities of the present invention will become apparent from the following description of embodiments given in conjunction with the accompanying drawings, in which:

FIG. 1 is a view exemplarily illustrating the characteristics in which the phase of a mode function that forms electromagnetic radiation is changed to n=1 and m=1;

FIG. 2 is a view exemplarily illustrating the characteristics in which the phase of a mode function that forms electromagnetic radiation is changed to n=5 and m=1;

FIG. 3 is a conceptual view explaining a communication system for transmitting and receiving wireless communication signals using the revolution division multiplexing according to the present invention;

FIG. 4 is a diagram illustrating the configuration of a transmitter for wireless communication using the revolution division multiplexing according to an embodiment of the present invention; and

FIG. 5 is a diagram illustrating the configuration of a receiver for wireless communication using the revolution division multiplexing according to an embodiment of the present invention.

### DETAILED DESCRIPTION OF THE EMBODIMENTS

The aspects and qualities of the present invention and methods for achieving the aspects and qualities will be apparent by referring to the embodiments to be described in detail with reference to the accompanying drawings. Here, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined by the scope of the appended claims.

Further, in the following description of the present invention, a detailed description of known functions and configurations incorporated herein will be omitted when it may make the subject matter of the present invention unclear. Also, the following terms are defined in consideration of the functions of the present invention, and may be differently defined according to the intention of an operator or custom. Therefore, the terms should be defined based on the overall contents of the specification.

Hereinafter, preferred embodiments of the present invention will be described in detail with reference to the accompanying drawings.

### Embodiment 1

First, according to the present invention, in order to increase the capacity of communication channels having the same frequency and polarized wave characteristics, revolution division multiplexing is performed through phase modulation of an azimuth angle and an elevation angle on 3D spherical coordinate system. For this, it is necessary to use the orthogonality of mode functions that constitute an electromagnetic wave so that desired signals can be discriminated even using the same frequency and the same polarized wave. Using mode functions M̅ₙₘ, N̅ₙₘ based on the electromagnetic wave theory, the mode functions of a radiation wave that an antenna generates have a form as in Equation 1 below in spherical coordinate system (r,θ,φ).

$${\overline{M}}_{n m} = {h}_{n}^{( 1 )} ( kr ) \frac{{e}^{ im φ}}{sin θ} [ im {P}_{n}^{m} ( cos θ ) \hat{θ} + {sin}^{2} θ \cdot {P}_{n}^{m} ( cos θ ) \hat{φ} ] \\ {\overline{N}}_{n m} = \frac{1}{k} \overline{∇} \times {\overline{M}}_{n m} \qquad [ Equation 1 ]$$

In Eguation 1 above, k denotes the wavenumber of an electromagnetic wave, hₙ⁽¹⁾(•) denotes the n-order first kind spherical Hankel function, Pₙ^{m}(•) denotes a Legendre function, and (•)′ denotes a derivative of a factor. By performing linear synthesis for Equation 1 as above, all electromagnetic fields that the antenna radiates can be formed. For example, the electric field that the antenna radiates can be expressed as in Equation 2 below:

$$\overline{E} = {\sum }_{n = 0}^{∞} {\sum }_{m = - n}^{n} ( {A}_{n m} {\overline{M}}_{n m} + {B}_{n m} {\overline{N}}_{n m} ) \qquad [ Equation 2 ]$$

In Equation 2 above, Aₙₘ,Bₙₘ denotes coefficients of mode functions. If the radiated electromagnetic field of the antenna is changed, the mode functions are maintained as they are, but the coefficients Aₙₘ,Bₙₘ thereof are changed.

In the general antenna application, θ=90° angle region (or x-y plane) that corresponds to ground of the elevation angle becomes the primarily concerned band. However, according to the present invention, the multiplexing method is proposed with concern of the characteristics in the vicinity of θ=0° (or z-axis). If it is assumed that the characteristics are limited to θ=0° region, the phase of the mode function is changed in diverse ways as n, m, which corresponds to the mode number in Equation 1 above, is changed.

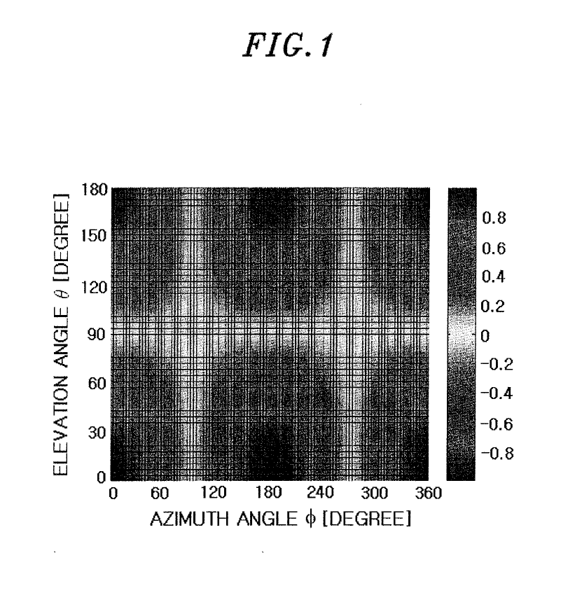

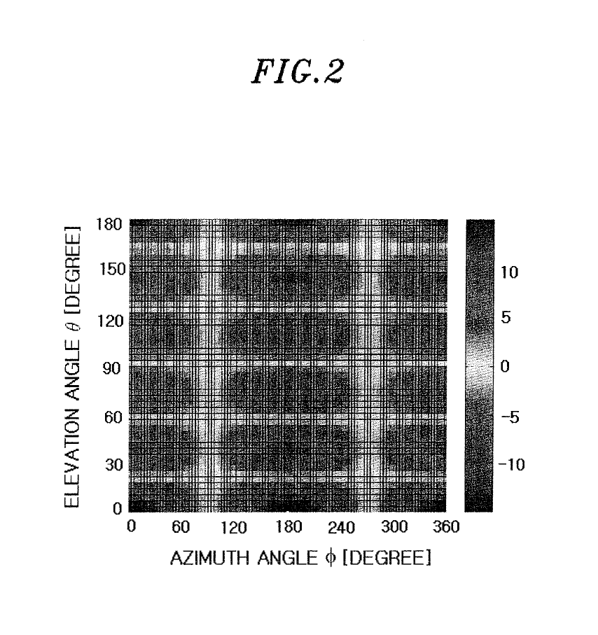

FIG. 1 is a view exemplarily illustrating the characteristics in which the phase of a mode function that forms electromagnetic radiation is changed to n=1 and m=1, and FIG. 2 is a view exemplarily illustrating the characteristics in which the phase of a mode function that forms electromagnetic radiation is changed to n=5 and m=1.

Accordingly, using the phase characteristics as described above, a new multiplexing technique can be realized which can certainly divide the synthesized signal by the orthogonality of the mode function even using the same frequency and the same polarized wave.

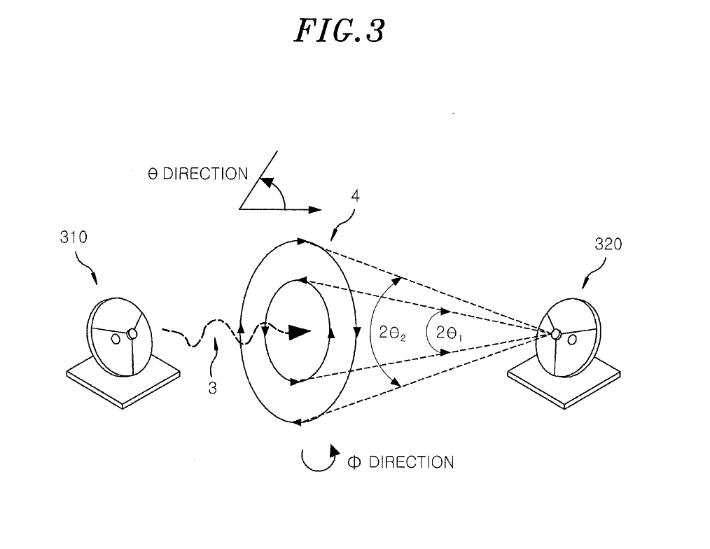

FIG. 3 is a conceptual view explaining a communication system for transmitting and receiving wireless communication signals using the revolution division multiplexing according to the present invention. The communication system may include a transmitter 310 and a receiver 320.

Referring to FIG. 3, the transmitter 310 may generate a plurality of electromagnetic wave mode functions having orthogonality in a spatial domain using a plurality of input signals, synthesize and wirelessly transmit the electromagnetic wave mode functions through an antenna (transmission antenna), and the receiver 320 may discriminate the electromagnetic wave mode functions through an orthogonal operation with respect to the revolution division multiplexing electromagnetic wave having the phase revolution characteristic in the azimuth angle and elevation angle directions, which is received through an antenna (reception antenna), and then restore an output signal through correction.

That is, the electromagnetic wave 3 that is generated by the transmitter 310 is wirelessly transmitted (sent) and radiated along z-axis toward the receiver 320, and unlike a general antenna radiation pattern, the electric field or the magnetic field 4 is rotated from the viewpoint of the phase on the basis of the direction 3 in which the electromagnetic wave propagates.

In this case, in order to make the revolution characteristic of the electric field or the magnetic field 4, the mode number of Equation 1 as described above is used. That is, when the antenna current density is excited, the surface structure of the antenna is adjusted or the amplitude and phase characteristics of antenna elements (e.g., current density of the array antenna) are adjusted to generate the corresponding mode number only, and this is because the corresponding mode can be accurately discriminated due to the orthogonality with respect to the mode function having the specific mode number only. Actually, all points can be received in the direction of the azimuth φ, whereas the maximum angle at which the observation becomes possible exists according to the size of the reception antenna in the direction of the elevation angle θ. For example, in FIG. 3, the reception antenna can sense only the regions where the condition of 0≦φ≦2π and θ≦θ₂ is satisfied.

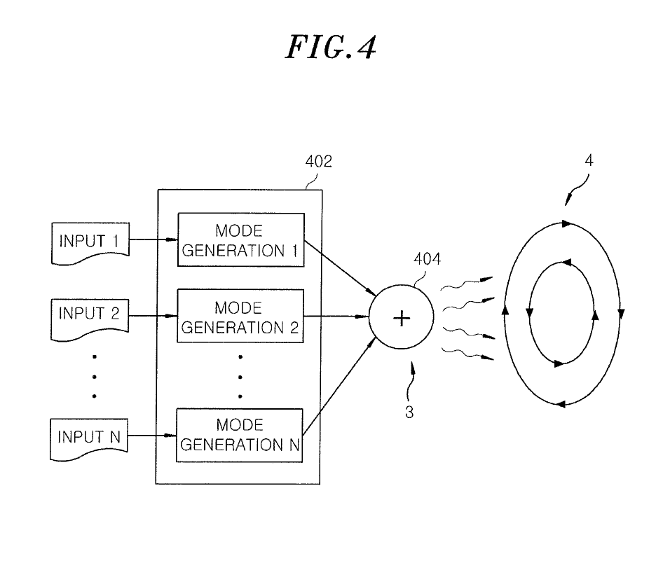

FIG. 4 is a diagram illustrating the configuration of a transmitter for wireless communication using the revolution division multiplexing according to an embodiment of the present invention. The transmitter may include a mode generation unit 402 and electromagnetic wave synthesis and transmission unit 404.

Referring to FIG. 4, the mode generation unit 402 may generate a plurality of mode functions (a plurality of electromagnetic wave mode functions) having orthogonality in a spatial domain using a plurality of input signals (input 1 to input N), and the electromagnetic wave synthesis and transmission unit 404 may synthesize the plurality of mode functions generated by the mode generation unit 402 and wirelessly transmit the synthesized mode function to the receiver side through the transmission antenna.

First, the electromagnetic wave mode functions having the orthogonality in the spatial domain may be generated using surface processing (adjustment of a surface structure) of a large-size antenna or amplitude and phase modulation of elements of the array antenna. If the input signals (input 1 to input N) that will excite the respective mode functions are input to the mode generation unit 402, they are synthesized by the transmission antenna, and are radiated into space in the form of an electromagnetic wave 3 as their phases are rotated 4 in the directions of the azimuth angle and the elevation angle.

Ideally, one input signal corresponds to one of coefficients Aₙₘ,Bₙₘ expressed in Equation 2 as above in a one-to-one manner. However, in practice, one input signal may correspond to several coefficients Aₙₘ,Bₙₘ, and this occurs due to the characteristics of the mode generation unit 402. That is, the density of current that flows in the antenna generates electromagnetic waves having specific radiation pattern by Maxwell equation, and thus the antenna current density may be considered as the input signals (input 1 to input N).

That is, the mode generation unit 402 makes desired mode functions by changing the amplitude and the phase of the current density, and in this case, if the amplitude and the phase of the current density are adjusted, the mode functions M̅ₙₘ, N̅ₙₘ expressed in Equation 1 as above can be selectively made. However, since errors occur inevitably when the amplitude and the phase are adjusted by the mode generation unit 402, the electromagnetic wave radiated through the antenna has various modes. This may be expressed as in Equation 3 below:

$$A = GJ \\ ≺ \text{=} ≻ [ \begin{matrix}Anm \\ Bnm\end{matrix} ] = [ \begin{matrix}G 11 & G 12 \\ G 21 & G 22\end{matrix} ] [ \begin{matrix}Jnm \\ Knm\end{matrix} ] \qquad [ Equation 3 ]$$

In Equation 3 as above, A denotes a matrix composed of mode function coefficients Aₙₘ,Bₙₘ, J denotes a matrix expressing the current density of an input signal, and G denotes a matrix of a mode generation unit that changes the current density of the input signal to mode functions of the electromagnetic wave. That is, if the mode generation unit 402 is ideally constructed, the matrix G becomes an identity matrix, whereas if an error occurs in the mode generation unit 402, the matrix G becomes a matrix having very large diagonal elements rather than the identity matrix.

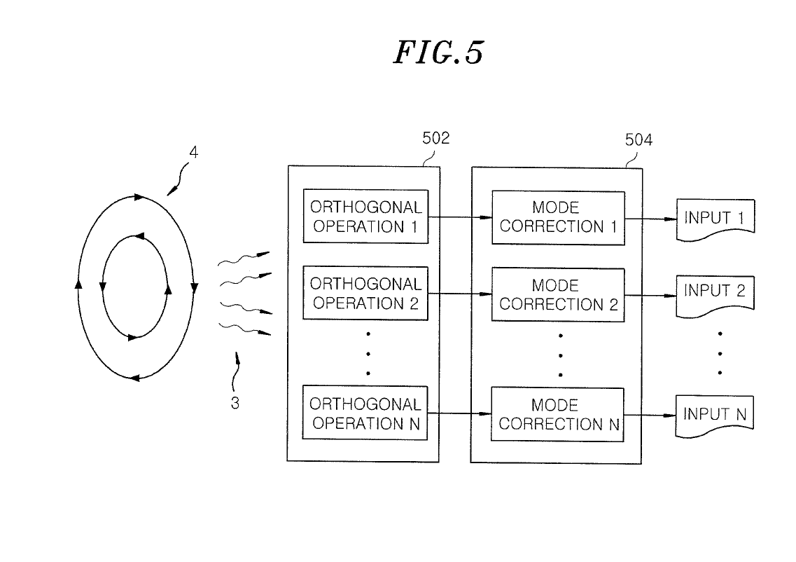

FIG. 5 is a diagram illustrating the configuration of a receiver for wireless communication using the revolution division multiplexing according to an embodiment of the present invention. The receiver may include an orthogonal operation unit 502 and a mode correction unit 504.

Referring to FIG. 5, the orthogonal operation unit 502 may discriminate electromagnetic wave mode functions through an orthogonal operation of a revolution division multiplexing electromagnetic wave having phase revolution characteristics in directions of the azimuth angle and the elevation angle that is received through the reception antenna. The mode correction unit 504 may restore an output signal through correction of the electromagnetic wave mode functions that are discriminated through the orthogonal operation unit 502.

First, if the revolution division multiplexing electromagnetic wave 3 having the characteristic of phase revolution 4 in the directions of the azimuth angle and the elevation angle is input to the reception antenna, the orthogonal operation unit 502 and the mode correction unit 504 detect the signal transmitted by the transmitter, and this may be expressed as in Equation 4 below:

J=G⁻¹A′=G⁻¹OE [Equation 4]

In Equation 4 as above, J denotes output signals (output 1 to output N) to be restored, G⁻¹ denotes the configuration of the mode correction unit 504 as an inverse matrix of the mode generation unit on the transmitter side, A′ denotes a matrix composed of mode function coefficients Aₙₘ,Bₙₘ generated in the receiver, E denotes an electric field matrix measured in the receiver, and O denotes a matrix of the orthogonal operation unit 502 that discriminates the mixed mode functions. Here, the orthogonal operation unit 502 may be defined as integration as expressed in Equation 5 below:

∫₀^{π}∫₀^{2π}Ē× N̅*ₚₗ·\hat{r} sin θdφdθ

∫₀^{π}∫₀^{2π}Ē× M̅*ₚₗ·\hat{r} sin θdφdθ [Equation 5]

As seen from the receiver side, all signals are unable to be detected in the direction of the elevation angle θ, and the maximum detection angle exists as shown in FIG. 3 as above. Accordingly, the orthogonality of the mode functions in Equation 5 as described above is not established in the direction of the elevation angle. Further, since Equation 5 is expressed as integration, received electric fields of all points, which are located at the azimuth angel and the elevation angle, should be detected. However, in consideration of Fourier series, components of the azimuth angle φ can be easily detected through Equation 6 below:

$${\sum }_{u = 1}^{U} {e}^{i ( m - l ) {φ}_{u}} = U {δ}_{m l} \qquad [ Equation 6 ]$$

In Equation 6 as above, φᵤ denotes a position that is measured in the azimuth angle direction. In order for Equation 6 to be established, φᵤ should be equally arranged in the azimuth angle direction, U=M, 2M, 3M, . . . should be established. Further, M denotes the maximum value of the mode number m of the mode function in the azimuth angle direction. Here, the synthesized value of the Legendre function may be expressed as differentiation of the Legendre function as in Equation 7 below:

$${\sum }_{v = 1}^{V} {P}_{n}^{m} ( cos {θ}_{v} ) {C}_{pv}^{m} {P}_{p}^{m} ( cos {θ}_{v} ) = {D}_{n} {δ}_{np} \qquad [ Equation 7 ]$$

In Equation 7 as above, constant Cₚᵥ^{m} denotes a component for detecting the mode number n in a measurement position θᵥ, and Dₙ denotes synthesized values of the Legendre function obtained when the mode numbers n and p are the same. Since the orthogonality of the mode function is not established in the elevation angle direction due to the measurement limit, the measurement position θᵥ should be determined to be optimized in numerical analysis. If Equation 7 as described above has an inverse matrix through adjustment of the constant Cₚᵥ^{m}, the orthogonality of the mode function can be artificially applied.

Accordingly, the measurement position θᵥ can be optimized as in Equation 8 below so as to minimize the condition number cond[P] of the following matrix P:

$$P = [ {\sum }_{v = 1}^{V} {P}_{n}^{m} ( cos {θ}_{v} ) {P}_{p}^{m} ( cos {θ}_{v} ) ] \\ = \text{≻} {}_{{θ}_{v}}^{min} [ cond [ P ] ] \qquad [ Equation 8 ]$$

In Equation 8 as above, a matrix P calculates the mode numbers n,p.

That is, according to a signal transmission and reception method for wireless communication using revolution division multiplexing according to the present invention, the transmitter generates a plurality of electromagnetic wave mode functions having orthogonality in a spatial domain using a plurality of input signals, and synthesizes and wirelessly transmits the generated electromagnetic wave mode functions to the receiver side, and the receiver receives a revolution division multiplexing electromagnetic wave having characteristics of phase rotation in directions of an azimuth angle and an elevation angle, discriminates the electromagnetic wave mode functions through an orthogonal operation, and restores an output signal through correction of the discriminated electromagnetic wave mode functions. Accordingly, the multiplexing can be realized through effective discrimination of the signals while using the same frequency and the same polarized wave in the UHF band.

The description of the present invention as described above is merely exemplary, and it will be understood by those of ordinary skill in the art to which the present invention pertains that various changes in form and detail may be made thereto without changing the technical idea or essential features of the present invention. Accordingly, it will be understood that the above-described embodiments are exemplary in all aspects, and do not limit the scope of the present invention.

Accordingly, the scope of the present invention is defined by the appended claims, and it will be understood that all technical features in the equivalent range fall within the scope of the present invention.

What is claimed is:

1. A transmitter for wireless communication using revolution division multiplexing, comprising:
a mode generation unit, which generates a plurality of electromagnetic wave mode functions having orthogonality in a spatial domain using a plurality of input signals; and
an electromagnetic wave synthesis and transmission unit, which synthesizes and wirelessly transmits the generated electromagnetic wave mode functions through a transmission antenna.

2. The transmitter for wireless communication of claim 1, wherein the mode generation unit generates the plurality of electromagnetic wave mode functions through adjustment of a surface structure of the transmission antenna.

3. The transmitter for wireless communication of claim 1, wherein the mode generation unit generates the plurality of electromagnetic wave mode functions through adjustment of amplitude and phase characteristics of elements of the transmission antenna.

4. The transmitter for wireless communication of claim 3, wherein the elements of the transmission antenna correspond to a current density of an array antenna.

5. The transmitter for wireless communication of claim 1, wherein the electromagnetic wave synthesis and transmission unit radiates the plurality of electromagnetic wave mode functions into space as rotating phases in directions of an azimuth angle and an elevation angle in the form of an electromagnetic wave.

6. A receiver for wireless communication using revolution division multiplexing, comprising:
an orthogonal operation unit discriminating electromagnetic wave mode functions through an orthogonal operation of a revolution division multiplexing electromagnetic wave having characteristics of phase rotation in directions of an azimuth angle and an elevation angle that is received through a reception antenna; and
a mode correction unit restoring an output signal through correction of the discriminated electromagnetic wave mode functions.

7. The receiver for wireless communication of claim 6, wherein the output signal is restored through a following equation,
J=G⁻¹A′=G⁻¹OE
where, J denotes output signals to be restored, G⁻¹ denotes a configuration of the mode correction unit as an inverse matrix of a mode generation unit on a transmitter side, A′ denotes a matrix composed of mode function coefficients Aₙₘ,Bₙₘ generated in the receiver, E denotes an electric field matrix measured in the receiver, and O denotes a matrix of the orthogonal operation unit that discriminates the mixed mode functions.

8. A signal transmission and reception method for wireless communication using revolution division multiplexing, comprising:
generating a plurality of electromagnetic wave mode functions having orthogonality in a spatial domain using a plurality of input signals;
synthesizing and wirelessly transmitting the generated electromagnetic wave mode functions;
receiving a revolution division multiplexing electromagnetic wave having characteristics of phase rotation in directions of an azimuth angle and an elevation angle, and discriminating the electromagnetic wave mode functions through an orthogonal operation; and
restoring an output signal through correction of the discriminated electromagnetic wave mode functions.

9. The signal transmission and reception method of claim 8, wherein the plurality of electromagnetic wave mode functions are generated through adjustment of a surface structure of a transmission antenna.

10. The signal transmission and reception method of claim 8, wherein the plurality of electromagnetic wave mode functions are generated through adjustment of amplitude and phase characteristics of elements of a transmission antenna.

11. The signal transmission and reception method of claim 10, wherein the elements of the transmission antenna correspond to a current density of an array antenna.

12. The signal transmission and reception method of claim 8, wherein the plurality of electromagnetic wave mode functions are radiated into space as phases thereof are rotated in directions of an azimuth angle and an elevation angle in the form of an electromagnetic wave.

13. The signal transmission and reception method of claim 8, wherein the output signal is restored through a following equation,
J=G⁻¹A′=G⁻¹OE
where, J denotes the output signal to be restored, G⁻¹ denotes a configuration of the mode correction unit for the correction as an inverse matrix of a mode generation unit on a transmitter side, A′ denotes a matrix composed of mode function coefficients Aₙₘ·Bₙₘ generated in the receiver, E denotes an electric field matrix measured in the receiver, and O denotes a matrix of the orthogonal operation unit that discriminates the mixed mode functions.
